(19) United States
(12) Patent Application Publication
(10) Pub. No.: US 2026/0058218 A1
(43) Pub. Date: Feb. 26, 2026

(54) ELECTRODE PLATE AND BATTERY

(71) Applicant: ZHUHAI COSMX BATTERY CO., LTD., Zhuhai (CN)

(72) Inventors: Xichao FU, Zhuhai (CN); Shichang ZHOU, Zhuhai (CN); Jiaxing WANG, Zhuhai (CN); Xiaofeng WU, Zhuhai (CN); Jichun XIE, Zhuhai (CN); Huan JIANG, Zhuhai (CN)

(73) Assignee: ZHUHAI COSMX BATTERY CO., LTD., Zhuhai (CN)

(21) Appl. No.: 19/371,980

(22) Filed: Oct. 28, 2025

Related U.S. Application Data
(63) Continuation of application No. PCT/CN2024/083803, filed on Mar. 26, 2024.

(30) Foreign Application Priority Data
Apr. 28, 2023 (CN) 202321016854.X

(51) Int. Cl. H01M 10/0585; H01M 4/02; H01M 4/36; H01M 10/0525

(52) U.S. Cl. CPC H01M 10/0585; H01M 4/366; H01M 10/0525; H01M 2004/027; H01M 2004/028

(57) ABSTRACT

An electrode plate includes a first current collector and a first active coating layer coated on a surface of the first current collector, and a plurality of grooves are disposed on the first active coating layer, on at least one side surface of the electrode plate, at intervals. By disposing a plurality of grooves on the first active coating layer of the electrode plate, a length of a migration path of an electrolyte in a negative electrode plate may be reduced, a lithium plating window may be expanded, a risk of lithium plating may be reduced, and a utilization rate of the negative electrode plate may be improved. Meanwhile, a potential of a side surface, close to a separator, of the negative electrode plate may be improved, the cycle performance of the battery may be improved, and a concentration of the electrolyte may be homogenized.

### CROSS-REFERENCE TO RELATED APPLICATIONS

The present application is a continuation application of International Application No. PCT/CN2024/083803, filed on Mar. 26, 2024, which claims priority to Chinese Patent Application No. 202321016854.X, filed on Apr. 28, 2023. All of the aforementioned applications are incorporated herein by reference in their entireties.

### TECHNICAL FIELD

The present disclosure relates to the field of battery technologies, and in particular, to an electrode plate, and further relates to a battery having the electrode plate.

### BACKGROUND

With advent of the 5G era, consumers put forward higher requirements for an energy density and a rate capability of a battery. In current industry, achieving fast charging inevitably requires some sacrifice in the energy density, and therefore, a new generation of polymer lithium-ion battery needs to achieve both a high-rate capability and a high energy density.

In a roll-pressing process of a negative electrode plate in a lithium-ion battery, a density of a negative electrode active coating layer, on both sides of the negative electrode plate, in direct contact with a press roller, is high, and porosity is low, so that a length of a migration path of an electrolyte in the negative electrode plate is increased, and this increase of the migration path may lead to a decrease in a rate capability of the negative electrode plate. In addition, in electrode plates, a side surface, close to a separator, of the negative electrode plate has a lower potential, along with uneven polarization and uneven electrolyte concentration distribution, resulting in a low utilization rate of the negative electrode plate and a higher risk of lithium plating.

### SUMMARY

In view of this, the present disclosure provides an electrode plate, and a battery having the electrode plate, which solves the problem that a length of a migration path of an electrolyte in a negative electrode plate is increased and the problem that a side surface, close to a separator, of the negative electrode plate has a lower potential.

In order to achieve the foregoing objectives, the present disclosure provides the following technical solutions.

An electrode plate includes a first current collector and a first active coating layer coated on a surface of the first current collector, and a plurality of grooves are disposed on the first active coating layer, on at least one side surface of the electrode plate, at intervals.

Optionally, in the above electrode plate, an extension direction of a long axis of each groove in the plurality of grooves is parallel to a width direction of the electrode plate, and the plurality of grooves are arranged at intervals along a length direction of the electrode plate; or, an extension direction of a long axis of each groove in the plurality of grooves is parallel to a length direction of the electrode plate, and the plurality of grooves are arranged at intervals along a width direction of the electrode plate; or, an extension direction of a long axis of each groove in the plurality of grooves forms an angle with a length direction of the electrode plate, and the angle ranges from 30° to 60°.

Optionally, in the above electrode plate, a distance between adjacent grooves in the plurality of grooves is a fixed value, or a distance between adjacent grooves in the plurality of grooves is gradually increased or gradually decreased.

Optionally, in the above electrode plate, an extension direction of a long axis of each groove in the plurality of grooves is parallel to a width direction of the electrode plate; along the width direction of the electrode plate, the first current collector has a first edge and a second edge opposite to each other; along the extension direction of the long axis of the groove, the groove has a first end and a second end opposite to each other; and the first end coincides with the first edge, and/or the second end coincides with the second edge.

Optionally, in the above electrode plate, an extension direction of a long axis of each groove in the plurality of grooves is parallel to a width direction of the electrode plate; along the width direction of the electrode plate, the first current collector has a first edge and a second edge opposite to each other; along the extension direction of the long axis of the groove, the groove has a first end and a second end opposite to each other; and a distance between the first end and the first edge ranges from 1 mm to 5 mm, and/or a distance between the second end and the second edge ranges from 1 mm to 5 mm.

Optionally, in the above electrode plate, a width of each groove in the plurality of grooves ranges from 1 μm to 150 μm; and/or a distance between adjacent grooves in the plurality of grooves ranges from 0.1 mm to 5 mm; and/or a depth of each groove in the plurality of grooves ranges from 1 μm to 40 μm.

Optionally, in the above electrode plate, a structure of the first active coating layer is a layered structure, and an extension direction of the layered structure is parallel to an extension direction of a long axis of each groove in the plurality of grooves.

A battery includes a positive electrode plate and a negative electrode plate, and the positive electrode plate and/or the negative electrode plate is the above electrode plate.

Optionally, in the above battery, the positive electrode plate includes a second current collector and a positive electrode tab located on one side of the second current collector; the positive electrode plate further includes a second active coating layer located on the second current collector and an insulating layer located on a junction region between the second current collector and the positive electrode tab; an extension direction of a long axis of a groove of the negative electrode plate is parallel to a width direction of the negative electrode plate; along the extension direction of the long axis of the groove, the groove has a first end and a second end opposite to each other; the first end is close to the insulating layer; and along a thickness direction of the negative electrode plate, a projection of an edge of the first end is covered by a projection of the insulating layer.

Optionally, in the above battery, along the thickness direction of the negative electrode plate, a projection of an edge of the second end is covered by a projection of the second active coating layer; and/or along the thickness direction of the negative electrode plate, at least part of a projection of the insulating layer is covered by a projection of the negative electrode plate.

Optionally, in the above battery, the positive electrode plate includes a second current collector and a positive electrode tab located on one side of the second current collector; the positive electrode plate further includes a second active coating layer located on the second current collector and an insulating layer located on a junction region between the second current collector and the positive electrode tab; along a width direction of the negative electrode plate, a first current collector of the negative electrode plate has a first edge and a second edge opposite to each other; the first edge is close to the insulating layer; an extension direction of a long axis of each groove in the plurality of grooves of the negative electrode plate is parallel to a length direction of the negative electrode plate, and the plurality of grooves are arranged at intervals in the width direction of the negative electrode plate; a groove closest to the first edge in the plurality of grooves is a first groove; and along a thickness direction of the negative electrode plate, a projection of the insulating layer at least partially overlaps with a projection of the first groove.

Optionally, in the above battery, a groove closest to the second edge in the plurality of grooves is a second groove; and along the thickness direction of the negative electrode plate, a projection of a side edge, closest to the second edge, of the second groove is within a projection of the second active coating layer.

Optionally, in the above battery, the negative electrode plate includes an extension region and a negative electrode body region; the extension region is located at an edge of the negative electrode body region; the negative electrode body region is disposed opposite to the positive electrode plate; and a groove of the negative electrode plate is disposed in the negative electrode body region, or a groove of the negative electrode plate includes an extension portion extending to the extension region.

Optionally, in the above battery, the negative electrode plate includes a first current collector and a negative electrode tab located on one side of the first current collector; the negative electrode plate further includes a first active coating layer located on the first current collector and partially on the negative electrode tab; and along a thickness direction of the negative electrode plate, a projection of an end portion of a groove of the negative electrode plate is located on the negative electrode tab.

Optionally, in the above battery, a liquid inlet direction of an electrolyte of the battery is parallel to an extension direction of a long axis of a groove of the negative electrode plate and/or an extension direction of a long axis of a groove of the positive electrode plate.

In the electrode plate and the battery provided by the present disclosure, by disposing a plurality of grooves on the first active coating layer of the electrode plate, a density of the active coating layer, on a side surface of the electrode plate, in direct contact with a press roller, is improved in a pressing roll process of the electrode plate, which is equivalent to constructing an oriented groove fast ion channel on a surface of the electrode plate. In this way, the problem that a length of a migration path of an electrolyte in a negative electrode plate is increased is solved, a lithium plating window is expanded, a risk of lithium plating is reduced, and a utilization rate of the negative electrode plate is improved. Meanwhile, a potential of a side surface, close to a separator, of the negative electrode plate is improved, the cycle performance of the battery is improved, a concentration of the electrolyte is homogenized, and the utilization rate and the energy density of the negative electrode plate are improved.

### BRIEF DESCRIPTION OF THE DRAWINGS

To more clearly illustrate technical solutions in the embodiments of the present disclosure, drawings that are required to be used in description of the embodiments will be briefly introduced below. Apparently, the drawings in the following description are some embodiments of the present disclosure. For those with ordinary skill in the art, other drawings may be obtained according to these drawings without creative work.

FIG. 1 is a distribution diagram of grooves on a negative electrode plate according to an embodiment of present disclosure.

FIG. 2A is a distribution diagram of grooves on a negative electrode plate according to another embodiment of present disclosure.

FIG. 2B is a distribution diagram of grooves on a negative electrode plate according to another embodiment of present disclosure.

FIG. 3 is a schematic diagram illustrating a positional relationship between a positive electrode plate and a negative electrode plate according to an embodiment of the present disclosure.

FIG. 4 is a schematic diagram illustrating a positional relationship between a positive electrode plate and a negative electrode plate according to another embodiment of the present disclosure.

FIG. 5 is a schematic diagram illustrating a positional relationship between a positive electrode plate and a negative electrode plate according to another embodiment of the present disclosure.

FIG. 6 is a schematic diagram illustrating a positional relationship between a positive electrode plate and a negative electrode plate according to another embodiment of the present disclosure.

FIG. 7 is a schematic diagram illustrating a positional relationship between a positive electrode plate and a negative electrode plate according to another embodiment of the present disclosure.

FIG. 8 is a schematic diagram illustrating a positional relationship between a positive electrode plate and a negative electrode plate according to another embodiment of the present disclosure.

FIG. 9 is a schematic diagram illustrating a positional relationship between a positive electrode plate and a negative electrode plate according to another embodiment of the present disclosure.

FIG. 10 is a schematic diagram illustrating a positional relationship between a positive electrode plate and a negative electrode plate according to another embodiment of the present disclosure.

FIG. 11 is a schematic diagram illustrating a positional relationship between a positive electrode plate and a negative electrode plate according to another embodiment of the present disclosure.

FIG. 12 is a schematic diagram illustrating a positional relationship between a positive electrode plate and a negative electrode plate according to another embodiment of the present disclosure.

FIG. 13 is a schematic diagram illustrating a positional relationship between a positive electrode plate and a negative electrode plate according to another embodiment of the present disclosure.

FIG. 14 is a schematic diagram illustrating a positional relationship between a positive electrode plate and a negative electrode plate according to another embodiment of the present disclosure.

FIG. 15 is a schematic structural diagram of a positive electrode plate according to an embodiment of the present disclosure.

FIG. 16 is a schematic structural diagram of a positive electrode plate according to an embodiment of the present disclosure.

FIG. 17 is a schematic structural diagram of a negative electrode plate according to an embodiment of the present disclosure.

### DETAILED DESCRIPTION OF THE EMBODIMENTS

The present disclosure provides an electrode plate, and further provides a battery having the electrode plate.

Technical solutions in the embodiments of the present disclosure will be described clearly and completely with reference to the drawings in the embodiments of the present disclosure. It is evident that the described embodiments are only a portion of the embodiments of the present disclosure, and not all of them. Based on the embodiments of the present disclosure, all other embodiments obtained by those of ordinary skill in the art without creative work should fall within the scope of protection of the present disclosure.

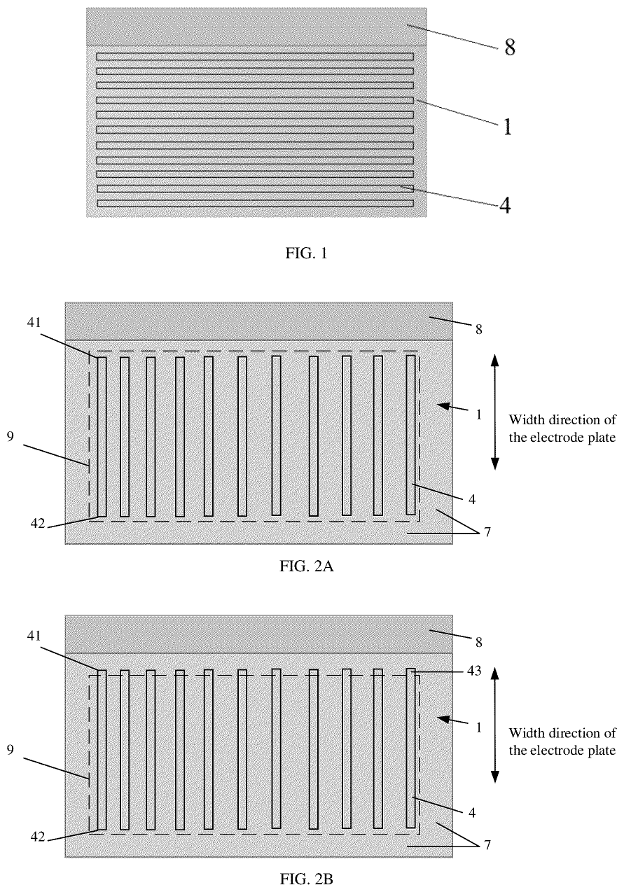

As shown in FIG. 1 to FIG. 14, an electrode plate includes a first current collector and a first active coating layer coated on a surface of the first current collector. A plurality of grooves 4 are disposed on the first active coating layer, on at least one side surface of the electrode plate, at intervals.

It should be noted that the above electrode plate is a negative electrode plate 1, the first current collector is a negative electrode current collector, and the first active coating layer is a negative electrode active coating layer. In other embodiments, the above electrode plate may be a positive electrode plate, the first current collector may be a positive electrode current collector, and the first active coating layer may be a positive electrode active coating layer.

It should be further noted that the groove 4 is obtained by thinning the negative electrode active coating layer through a laser manner, or the groove 4 is obtained by other physical mechanical manners.

A manufacturing process of the groove 4 may be performed after a process for coating the negative electrode active coating layer, or may be performed after a roll-pressing process of the negative electrode plate 1.

By disposing a plurality of grooves 4 on the negative electrode active coating layer of the negative electrode plate 1, the density of the negative electrode active coating layer, on a side surface of the negative electrode plate 1, in direct contact with the press roller, is improved in the pressing roll process of the electrode plate, which is equivalent to constructing an oriented groove fast ion channel on a surface of the negative electrode plate 1. In this way, the problem that the length of the migration path of the electrolyte in the negative electrode plate 1 is increased is solved, the lithium plating window is expanded, the risk of lithium plating is reduced, and the utilization rate of the negative electrode plate 1 is improved. Meanwhile, the potential of a side surface, close to a separator, of the negative electrode plate 1 is improved, the cycle performance of the battery is improved, the concentration of the electrolyte is homogenized, and the utilization rate and the energy density of the negative electrode plate 1 are improved.

Referring to FIG. 2A or FIG. 2B, in some embodiments of the present disclosure, an extension direction of a long axis of the groove 4 is parallel to a width direction of the negative electrode plate 1, and the plurality of grooves 4 are arranged at intervals along a length direction of the negative electrode plate 1.

Referring to FIG. 1, in some embodiments of the present disclosure, an extension direction of a long axis of the groove 4 is parallel to a length direction of the negative electrode plate 1, and the plurality of grooves 4 are arranged at intervals along a width direction of the negative electrode plate 1.

In some embodiments, a surface of the first current collector may include a foil uncoating region 8, and the foil uncoating region 8 may be a region that is not coated with the first active coating layer.

In some embodiments of the present disclosure, an extension direction of a long axis of the groove 4 forms an angle with a length direction of the negative electrode plate 1, and the angle ranges from 30° to 60°.

It should be noted that the groove 4 is formed progressively along a long axis direction of the groove 4.

With the above configuration, it is ensured that starting ends of all the formed grooves 4 are located on a same straight line, and terminating ends of all the formed grooves 4 are also located on a same straight line. Both of the two straight lines are parallel to the length direction of the negative electrode plate 1 or parallel to the width direction of the negative electrode plate 1, thereby ensuring that the toolpath during a forming process of the groove 4 is easy to be accurately managed and controlled, and ensuring the precision and consistency of the formed groove 4.

Referring to FIG. 1, in some embodiments of the present disclosure, a distance between adjacent grooves 4 is a fixed value.

With the above configuration, the consistency of parameters for forming the grooves 4 is ensured, and the convenience for forming the groove 4 is ensured.

Referring to FIG. 2A or FIG. 2B, in some embodiments of the present disclosure, the long axis of the groove 4 is parallel to the width direction of the negative electrode plate 1, and all of the grooves 4 are arranged at intervals along the length direction of the negative electrode plate 1. A distance between adjacent grooves 4 is gradually increased, or the distance between adjacent grooves 4 is gradually decreased.

With the above configuration, it can be ensured that the number of the grooves 4 is reduced.

In some embodiments of present disclosure, the long axis of the groove 4 is parallel to a width direction of the negative electrode plate 1. Along the width direction of the negative electrode plate 1, the negative electrode current collector of the negative electrode plate 1 has a first edge and a second edge opposite to each other, along an extension direction of the long axis of the groove 4, the groove 4 has a first end 41 and a second end 42 opposite to each other, and the first end 41 of the groove 4 coincides with the first edge of the negative electrode current collector.

Further, the second end 42 of the groove 4 coincides with the second edge of the negative electrode current collector.

With the above configuration, it may be ensured that an extension length of the formed groove 4 is maximized, the density of the active coating layer on a side surface of the negative electrode plate is effectively improved, and it is further ensured that the length of the migration path of the electrolyte on the negative electrode plate 1 is not increased.

In some embodiments of the present disclosure, the first end of the groove 4 is close to the first edge of the negative electrode current collector, and a distance between the first end of the groove 4 and the first edge of the negative electrode current collector ranges from 1 mm to 5 mm.

Further, the second end of the groove 4 is close to the second edge of the negative electrode current collector, and a distance between the second end of the groove 4 and the second edge of the negative electrode current collector ranges from 1 mm to 5 mm.

With the above configuration, it is ensured that the groove 4 is not disposed at a thinned region of the negative electrode plate 1, thereby ensuring the thickness and the lithium intercalation capability of the thinned region, and ensuring the safety performance of the battery.

In some embodiments of the present disclosure, the groove 4 is a rectangular groove; and along an extension direction of a short axis of the groove 4, a width of the groove 4 ranges from 1 μm to 150 μm.

Preferably, along the extension direction of the short axis of the groove 4, the width of the groove 4 ranges from 60 μm to 90 μm.

Further, a distance between adjacent grooves 4 ranges from 0.1 mm to 5 mm.

Preferably, the distance between adjacent grooves 4 ranges from 0.5 mm to 3 mm.

Further, a depth of the groove 4 ranges from 1 μm to 40 μm.

Preferably, the depth of the groove 4 ranges from 15 μm to 23 μm.

The aforementioned parameter configuration of the groove 4 improves the density of the negative electrode active coating layer on the surface of the negative electrode plate 1 on the premise of ensuring sufficient lithium intercalation capability of the negative electrode active coating layer, and this parameter configuration is an optimal parameter configuration for constructing an oriented groove fast ion channel.

It should be noted that the size of the formed groove 4 is adaptively adjusted with the length size and the width size of the negative electrode plate 1. A region for forming the groove is disposed along the length direction and/or the width direction of the negative electrode plate 1, so as to improve the compatibility of the process for forming groove to different batteries and improve the process efficiency.

In summary, the present disclosure provides a battery, the battery includes a positive electrode plate and a negative electrode plate, and the negative electrode plate is the negative electrode plate described above.

The battery further includes a separator 3, and the separator 3 is disposed between the negative electrode plate 1 and the positive electrode plate 2.

Since the battery of the present disclosure has the negative electrode plate described above, the beneficial effects of the battery caused by the negative electrode plate are described above, and details are not described herein again.

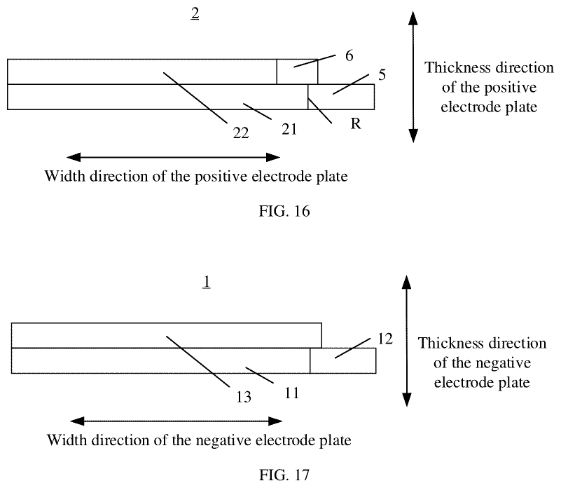

Referring to FIG. 15 and FIG. 16, in some embodiments of the present disclosure, the positive electrode plate 2 includes a second current collector 21 and a positive electrode tab 5 located on one side of the second current collector 21. The positive electrode plate further includes a second active coating layer 22 located on the second current collector 21 and an insulating layer 6 located on a junction region R between the second current collector 21 and the positive electrode tab 5.

An extension direction of a long axis of the groove 4 of the negative electrode plate 1 is parallel to a width direction of the negative electrode plate 1; along an extension direction of a long axis of the groove 4, the groove 4 has a first end and a second end opposite to each other; the first end of the groove 4 is close to the insulating layer 6; and along a thickness direction of the negative electrode plate 1, a projection of an edge of the first end of the groove 4 is covered by a projection of the insulating layer 6.

It should be noted that the second current collector is a positive electrode current collector, and the second active coating layer is a positive electrode active coating layer.

The insulating layer 6 is a TA4 adhesive disposed on the second current collector.

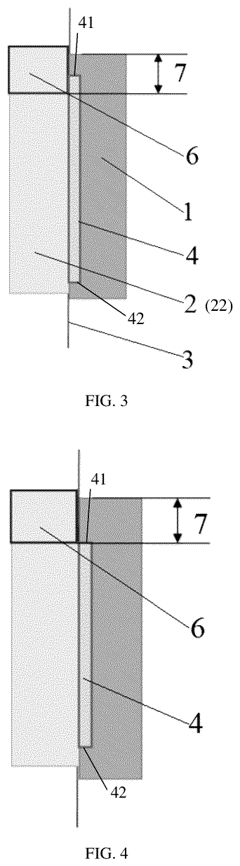

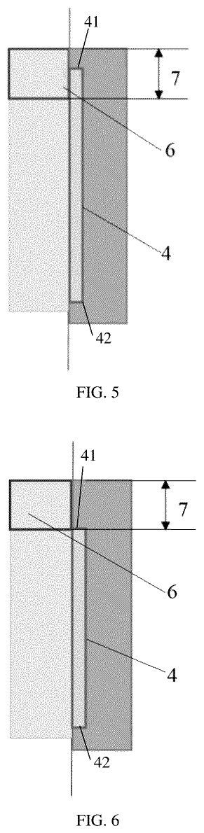

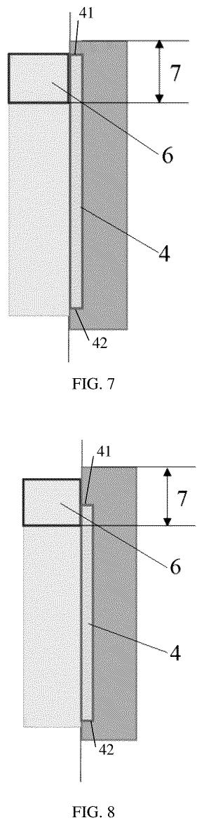

As can be seen from the above, there are three positional relationships between the edge of the first end of the groove 4 and the insulating layer 6:
(1) the edge of the first end of the groove 4 is flush with the edge, away from the second active coating layer, of the insulating layer 6, as shown in FIG. 7;
(2) the edge of the first end of the groove 4 is located at the middle of the insulating layer 6, as shown in FIG. 3, FIG. 5 and FIG. 8; and
(3) the edge of the first end of the groove 4 is flush with an edge, close to the second active coating layer, of the insulating layer 6, as shown in FIG. 4 and FIG. 6.

With the above configuration, it may be ensured that the insulating layer 6 covers burrs at the edge of the first end of the groove 4, thereby preventing the burrs from piercing the separator and causing a battery short circuit, thus improving the safety performance of the battery.

Referring to FIG. 3 to FIG. 8, in some embodiments of the present disclosure, the extension direction of the long axis of the groove 4 is parallel to the width direction of the negative electrode plate 1. Along the thickness direction of the negative electrode plate 1, a projection of an edge of the second end of the groove 4 is covered by a projection of the second active coating layer.

With the above configuration, it can be ensured that the length of the formed groove 4 is not too long, thereby preventing the second end of the groove 4 from extending into a portion of the negative electrode plate 1 that overhangs the positive electrode plate 2, and thus avoiding lithium-ion deposition and resultant lithium plating.

Further, along a thickness direction of the negative electrode plate 1, at least part of a projection of the insulating layer 6 is covered by a projection of the negative electrode plate 1.

As can be seen from the above, there are three positional relationships between the negative electrode plate 1 and the insulating layer 6:
(1) an edge, close to the insulating layer 6, of the negative electrode plate 1 extends beyond an edge, away from the second active coating layer, of the insulating layer 6, as shown in FIG. 7 and FIG. 8;
(2) the edge, close to the insulating layer 6, of the negative electrode plate 1 is flush with the edge, away from the second active coating layer, of the insulating layer 6, as shown in FIG. 5 and FIG. 6; and
(3) the edge, close to the insulating layer 6, of the negative electrode plate 1 is located at the middle of the insulating layer 6, as shown in FIG. 3 and FIG. 4.

With the above configuration, it can be ensured that the negative electrode plate 1 has an extension region extending beyond the positive electrode plate 2 relative to the positive electrode plate 2, thereby effectively preventing lithium plating.

In some embodiments of the present disclosure, an extension direction of the long axis of the groove 4 is parallel to the length direction of the negative electrode plate 1, and the plurality of grooves 4 are arranged at intervals along the width direction of the negative electrode plate 1. Along the width direction of the negative electrode plate 1, the negative electrode current collector has a first edge and a second edge opposite to each other, and the first edge is close to the insulating layer 6. Along the width direction of the negative electrode plate 1, a groove 4 closest to the first edge of the negative electrode current collector in the plurality of grooves 4 is a first groove. Along a thickness direction of the negative electrode plate 1, a projection of the insulating layer 6 at least partially overlaps with a projection of the first groove.

With the above configuration, it is ensured that a region with the positive electrode active coating layer on the positive electrode plate 2 is comprehensively opposite to the position of the grooves 4 formed on the negative electrode plate 1, thereby maximizing the rate capability of the battery during charging and discharging.

Preferably, a side edge closest to the first edge of the negative electrode current collector in the first groove is a first side edge. A side edge, away from the first edge of the negative electrode current collector, in the first groove is a third side edge.

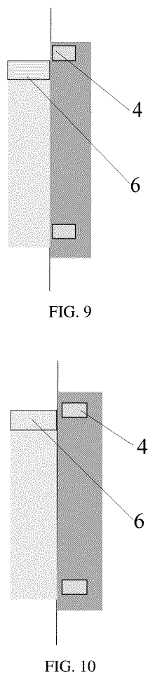

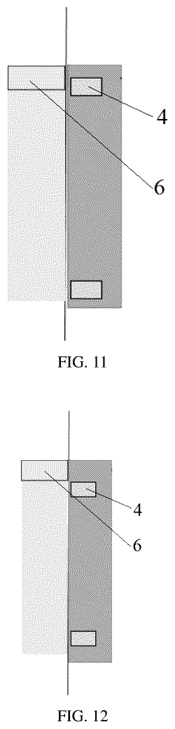

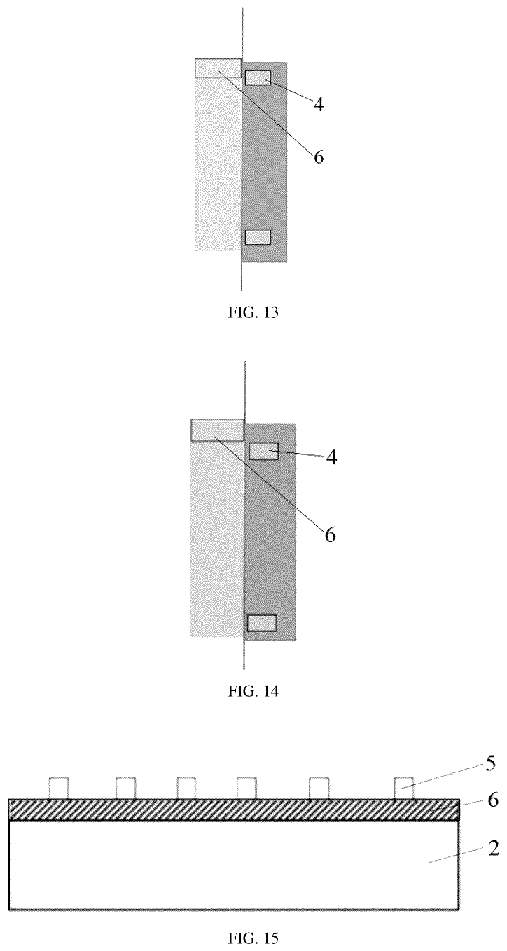

There are four positional relationships between the first groove and the insulting layer 6:
(1) the first side edge of the first groove is flush with the edge, away from the second active coating layer, of the insulating layer 6;
(2) the first side edge of the first groove is located at the middle of the insulating layer 6, as shown in FIG. 11 and FIG. 13;
(3) the first side edge of the first groove is flush with the edge, close to the second active coating layer, of the insulating layer 6, as shown in FIG. 12 and FIG. 14; and
(4) the first side edge of the first groove extends beyond the insulating layer 6, as shown in FIG. 9 and FIG. 10.

With the above configuration, according to the positional relationships (1), (2), and (3) between the first groove and the insulating layer 6, it can be ensured that the insulating layer 6 covers burrs at the first side edge of the first groove, thereby preventing the burrs from piercing the separator and causing a battery short circuit, thus improving the safety performance of the battery. The positional relationship (4) between the first groove and the insulating layer 6 may effectively increase the number of grooves 4 that can be formed.

Referring to FIG. 9 to FIG. 14, further, a groove 4 closest to the second edge of the negative electrode current collector in the plurality of grooves 4 is a second groove. A side edge closest to the second edge of the negative electrode current collector in the second groove is a second side edge. Along a thickness direction of the negative electrode plate 1, a projection of the second side edge is within a projection of the second active coating layer.

With the above configuration, along the width direction of the negative electrode plate 1, it can be ensured that the grooves 4 do not extend into a portion of the negative electrode plate 1 that overhangs the positive electrode plate 2, thereby preventing lithium-ion deposition and lithium plating, and consequently enhancing the safety performance of the battery.

In some embodiments of the present disclosure, the negative electrode plate 1 includes an extension region 7 and a negative electrode body region 9. The extension region 7 is located at an edge of the negative electrode body region 9, and a position of the negative electrode body region 9 is opposite to a position of the positive electrode plate 2. A boundary of the groove 4 does not extend beyond the extension region 7.

With the above configuration, it can be ensured that the positions of the grooves 4 formed on the negative electrode plate 1 are located at the body region, opposite to the position of the positive electrode plate, of the negative electrode plate, thereby effectively improving the safety performance of the battery.

Alternatively, referring to FIG. 2B, the groove 4 includes an extension portion 43 extending to the extension region.

Further, a distance between a side edge, close to the first edge of the negative electrode current collector, of the extension portion 43 and the first edge of the negative electrode current collector ranges from 1 mm to 2 mm.

With the above configuration, the extension length of the long axis of the formed groove 4 or the number of the grooves 4 can be ensured, thereby maximizing the improvement in the density of the surface of the negative electrode active coating layer on the negative electrode plate 1 and facilitating the migration path of lithium ions from the electrolyte within the negative electrode plate 1.

Further, along the length direction of the negative electrode plate 1, the groove 4 does not extend into the extension region 7.

With the above configuration, it is ensured that the formed groove 4 does not extend into a portion of the negative electrode plate 1 that overhangs the positive electrode plate 2, thereby effectively enhancing the safety performance of the battery.

In some embodiments of the present disclosure, all of the grooves 4 are formed on the negative electrode body region.

With the above configuration, the manufacturing process may be simplified, the electrode misalignment may be prevented, the preparation efficiency may be improved, and the safety performance of the battery may also be effectively improved.

In some embodiments of the present disclosure, a liquid inlet direction of an electrolyte of the battery is parallel to a long axis of the groove 4.

With the above configuration, it is ensured that the liquid inlet direction of the electrolyte is consistent with the direction of the long axis of the groove 4, which facilitates the infiltration and absorption of the electrolyte and effectively improves the infiltration time of the electrolyte.

Further, a structure of the first active coating layer is a layered structure, and an extension direction of the layered structure is parallel to the long axis direction of the groove 4.

With the above configuration, the efficiency of manufacturing process is improved, and the battery cell cycle performance is improved.

It should be noted that the grooves 4 are distributed on one or both side surfaces of the negative electrode plate 1, and the grooves 4 respectively located on the two side surfaces of the negative electrode plate 1 may be parallel to or intersect each other. An alignment degree of the grooves 4 on the two side surfaces of the negative electrode plate 1 is not limited, so that the efficiency and yield rate of the manufacturing process are improved without affecting the performance of the battery.

Further, the groove 4 on the negative electrode plate 1 of the present disclosure may be compatible with a negative electrode current collector having a thickness of 4 μm to 12 μm, adapting to both a thick electrode plate with a high energy density and a thin electrode plate with a high rate.

The structure of the battery of the present disclosure may be applied to a wound lithium-ion battery and a laminated lithium-ion battery.

In some embodiments of the present disclosure, referring to FIG. 17, the negative electrode plate 1 includes a negative electrode current collector 11 and a negative electrode tab 12 located on one side of the negative electrode current collector 11. The negative electrode plate 1 further includes a negative electrode active coating layer 13 located at the negative electrode current collector 11 and a part of the negative electrode tab 12. In the thickness direction of the negative electrode plate 1, a projection of an end portion of the groove 4 is located on the negative electrode tab 12.

When the first end and the second end of the groove 4 respectively coincide with the edges of the negative electrode plate 1, the formed groove 4 extends to the negative electrode tab.

The above configuration may maximize the extension length of groove 4, thereby ensuring the charging and discharging performance at the negative electrode tab.

Components or apparatuses involved in the present disclosure are merely provided as illustrative examples and are not intended to require or imply that the components or the apparatuses must be connected, arranged or configured according to the accompanying drawings. As those skilled in the art will recognize, the components or the apparatuses may be connected, arranged or configured in any manner. Terms such as “including”, “containing”, “having” and the like are open-ended words that mean “including but not limited to” and may be used interchangeably therewith. The terms “or” and “and” used herein refer to the term “and/or” and may be used interchangeably, unless the context clearly dictates otherwise. The term “such as” used herein refers to the phrase “such as, but not limited to” and may be used interchangeably therewith.

It should also be noted that, in the apparatus of the present disclosure, each component may be disassembled and/or reconfigured. Such disassembly and/or reconfiguration shall be considered as equivalent solutions of the present disclosure.

The above descriptions of the disclosed aspects are provided to enable any person skilled in the art to make or use the present disclosure. Various modifications to these aspects are readily apparent to a person skilled in the art, and the generic principles defined herein may be applied to other aspects without departing from the scope of the present disclosure. Thus, the present disclosure is not intended to be limited to the aspects shown herein, but is to be accorded the broadest scope consistent with the principles and novel features disclosed herein.

The above descriptions have been presented for purposes of illustration and description. Moreover, such descriptions are not intended to limit the embodiments of the present disclosure to the forms disclosed herein. Although various example aspects and embodiments have been discussed above, a person skilled in the art will recognize certain variations, modifications, changes, additions, and sub-combinations thereof.

The above are only preferred embodiments of the present disclosure and are not intended to limit the present disclosure, and any modification, equivalent replacement, etc. made within the spirit and the principles of the present disclosure shall fall within the protection scope of the present disclosure.

What is claimed is:

1. A battery, comprising a positive electrode plate and a negative electrode plate, wherein the negative electrode plate comprises a first current collector and a first active coating layer coated on a surface of the first current collector, and a plurality of grooves are disposed on the first active coating layer, on at least one side surface of the negative electrode plate, at intervals;
the positive electrode plate comprises a second current collector, a positive electrode tab located on one side of the second current collector, a second active coating layer located on the second current collector, and an insulating layer located on a junction region between the second current collector and the positive electrode tab;
an extension direction of a long axis of each groove in the plurality of grooves is parallel to a width direction of the negative electrode plate, along the extension direction of the long axis of the groove, the groove has a first end and a second end opposite to each other, and the first end is close to the insulating layer; and
along a thickness direction of the negative electrode plate, a projection of an edge of the first end is covered by a projection of the insulating layer.

2. The battery according to claim 1, wherein the plurality of grooves are arranged at intervals along a length direction of the negative electrode plate.

3. The battery according to claim 1, wherein along the width direction of the negative electrode plate, the first current collector has a first edge and a second edge opposite to each other; and the first end coincides with the first edge, and/or the second end coincides with the second edge.

4. The battery according to claim 1, wherein along the width direction of the negative electrode plate, the first current collector has a first edge and a second edge opposite to each other; and a distance between the first end and the first edge ranges from 1 mm to 5 mm, and/or a distance between the second end and the second edge ranges from 1 mm to 5 mm.

5. The battery according to claim 1, wherein a distance between adjacent grooves in the plurality of grooves is a fixed value, or
a distance between adjacent grooves in the plurality of grooves is gradually increased or gradually decreased.

6. The battery according to claim 1, wherein a width of each groove in the plurality of grooves ranges from 1 μm to 150 μm.

7. The battery according to claim 1, wherein a distance between adjacent grooves in the plurality of grooves ranges from 0.1 mm to 5 mm.

8. The battery according to claim 1, wherein a depth of each groove in the plurality of grooves ranges from 1 μm to 40 μm.

9. The battery according to claim 1, wherein a structure of the first active coating layer is a layered structure, and an extension direction of the layered structure is parallel to the extension direction of the long axis of each groove in the plurality of grooves.

10. The battery according to claim 1, wherein along the thickness direction of the negative electrode plate, a projection of an edge of the second end is covered by a projection of the second active coating layer.

11. The battery according to claim 1, wherein along the thickness direction of the negative electrode plate, at least part of a projection of the insulating layer is covered by a projection of the negative electrode plate.

12. The battery according to claim 1, wherein the negative electrode plate comprises an extension region and a negative electrode body region, the extension region is located at an edge of the negative electrode body region, and the negative electrode body region is disposed opposite to the positive electrode plate; and
the groove is disposed in the negative electrode body region, or the groove comprises an extension portion extending to the extension region.

13. The battery according to claim 1, wherein the negative electrode plate further comprises a negative electrode tab located on one side of the first current collector, and the first active coating layer covers the first current collector and a part of the negative electrode tab; and
along the thickness direction of the negative electrode plate, a projection of the first end or the second end of the groove is located on the negative electrode tab.

14. The battery according to claim 1, wherein a liquid inlet direction of an electrolyte of the battery is parallel to a long axis direction of the groove.

15. The battery according to claim 1, wherein the second active coating layer, on at least one side surface of the positive electrode plate, is provided with a plurality of grooves at intervals.

16. A battery, comprising a positive electrode plate and a negative electrode plate,
wherein the negative electrode plate comprises a first current collector and a first active coating layer coated on a surface of the first current collector, and a plurality of grooves are disposed on the first active coating layer, on at least one side surface of the negative electrode plate, at intervals;
the positive electrode plate comprises a second current collector, a positive electrode tab located on one side of the second current collector, a second active coating layer located on the second current collector, and an insulating layer located on a junction region between the second current collector and the positive electrode tab;
along a width direction of the negative electrode plate, the first current collector has a first edge and a second edge opposite to each other, and the first edge is close to the insulating layer;
an extension direction of a long axis of each groove in the plurality of grooves is parallel to a length direction of the negative electrode plate, the plurality of grooves are arranged at intervals along the width direction of the negative electrode plate, and a groove closest to the first edge in the plurality of grooves is a first groove; and
along a thickness direction of the negative electrode plate, a projection of the insulating layer at least partially overlaps with a projection of the first groove.

17. The battery according to claim 16, wherein a groove closest to the second edge in the plurality of grooves is a second groove; and
along the thickness direction of the negative electrode plate, a projection of a side edge, closest to the second edge, of the second groove is within a projection of the second active coating layer.

18. The battery according to claim 16, wherein the negative electrode plate comprises an extension region and a negative electrode body region, the extension region is located at an edge of the negative electrode body region, and the negative electrode body region is disposed opposite to the positive electrode plate; and
the groove is disposed in the negative electrode body region, or the groove comprises an extension portion extending to the extension region.

19. The battery according to claim 16, wherein the negative electrode plate further comprises a negative electrode tab located on one side of the first current collector, and the first active coating layer covers the first current collector and a part of the negative electrode tab; and
along the thickness direction of the negative electrode plate, a projection of an end portion of the groove is located on the negative electrode tab.

20. The battery according to claim 16, wherein a liquid inlet direction of an electrolyte of the battery is parallel to a long axis direction of the groove.
